(19) United States
(12) Patent Application Publication
(10) Pub. No.: US 2005/0235845 A1
(43) Pub. Date: Oct. 27, 2005

(54) Modular stencil system having interlocking stencils

(76) Inventor: Michael R. Hollis, Cleveland, OH (US)

Correspondence Address: PEARNE & GORDON LLP, 1801 EAST 9TH STREET, SUITE 1200, CLEVELAND, OH, 44114-3108, US

(21) Appl. No.: 11/115,884

(22) Filed: Apr. 27, 2005

Related U.S. Application Data
(60) Provisional application No. 60/565,581, filed on Apr. 27, 2004.

(51) Int. Cl. B41F 15/34

(52) U.S. Cl. 101/128.1

(57) ABSTRACT

A stencil system comprising a first stencil body comprising a first stencil aperture and a raised joining protrusion that extends away from a top surface of the first stencil body; and a second stencil body comprising a second stencil aperture and a joining protrusion receiving aperture, wherein said first stencil body and said second stencil body are connectable by a press fit joint between said raised joining protrusion and said joining protrusion receiving aperture.

### CROSS-REFERENCE TO RELATED APPLICATIONS

Benefit of U.S. Provisional Patent Application Ser. No. 60/565,581, filed Apr. 27, 2004, is hereby claimed and the disclosure incorporated herein by reference.

### BACKGROUND OF THE INVENTION

1. Field of the Invention

The present invention relates to stencils, and more particularly to a plurality of stencils which can be assembled in a desired order for transferring letters, numbers and other symbols.

2. Description of Related Art

Stencils are useful for creating letters, numbers and other symbols on a surface. Stencils that lock together, or interlocking stencils, may provide for the creation of consistently spaced letters, numbers and other symbols along a desired axis. However, the assembly and disassembly of interlocking stencils may require several complex and time-consuming steps. Interlocking stencils that are suitable for quick and easy assembly and disassembly would be beneficial.

### BRIEF SUMMARY OF THE INVENTION

Provided is a stencil system comprising a first stencil body comprising a first stencil aperture and a raised joining protrusion that extends away from a top surface of the first stencil body; and a second stencil body comprising a second stencil aperture and a joining protrusion receiving aperture, wherein said first stencil body and said second stencil body are connectable by a press fit joint between said raised joining protrusion and said joining protrusion receiving aperture.

Also provided is a stencil system comprising a first stencil body comprising a first stencil aperture and a raised joining protrusion that extends away from a top surface of the first stencil body, said raised joining protrusion comprising a first latching finger and a second latching finger, and a second stencil body comprising a second stencil aperture and a joining protrusion receiving aperture, wherein said first stencil body and said second stencil body are connectable by a resilient latching joint between said raised joining protrusion and said joining protrusion receiving aperture.

Further provided is a stencil for connection to other stencils, the stencil comprising a stencil body defining a stencil aperture, said stencil aperture comprising a beveled edge having at least one bevel angle, wherein said at least one bevel angle is less than ninety degrees, an offset portion of the stencil body for overlapping a stencil body of another stencil, and a joining structure being provided on the offset portion.

Further provided is a modular stencil system, comprising a first stencil body comprising a first cylindrical raised joining protrusion that extends away from a top surface of said first stencil body, a second cylindrical raised joining protrusion that extends away from the top surface of said first stencil body, a first offset portion comprising a first lateral projection and a second lateral projection, a first joining protrusion receiving aperture on said first lateral projection, a second joining protrusion receiving aperture on said second lateral projection, and a first stencil aperture, wherein said first stencil aperture is defined by a first beveled edge having a first bevel angle of approximately 45 degrees, and further wherein said first stencil body comprises a polymer and is formed by an injection molding process, and a second stencil body comprising a third cylindrical raised joining protrusion that extends away from a top surface of said second stencil body, a fourth cylindrical raised joining protrusion that extends away from the top surface of said second stencil body, a second offset portion comprising a third lateral projection and a fourth lateral projection, a third joining protrusion receiving aperture on said third lateral projection, a fourth joining protrusion receiving aperture on said fourth lateral projection, and a second stencil aperture, wherein said second stencil aperture is defined by a second beveled edge having a second bevel angle of approximately 45 degrees, and further wherein said second stencil body comprises a polymer and is formed by an injection molding process, and further wherein said first stencil body and said second stencil body are connectable by a press fit joint between said first cylindrical raised joining protrusion and one of said third joining protrusion receiving aperture and said fourth joining protrusion receiving aperture, and further wherein said first stencil body and said second stencil body are connectable by a press fit joint between said second cylindrical raised joining protrusion and the other one of said third joining protrusion receiving aperture and said fourth joining protrusion receiving aperture, and further wherein a surface of said first stencil body and a portion of said second stencil body are substantially coplanar when said first stencil body is connected to said second stencil body.

### BRIEF DESCRIPTION OF THE DRAWINGS

FIG. 1 is a perspective view of a stencil according to an embodiment of the present invention;

FIGS. 2A and 2B are perspective views of a first stencil to be connected to a second stencil according the embodiment of FIG. 1;

FIGS. 3A and 3B are perspective views of the first stencil connected to the second stencil of FIGS. 2A and 2B;

FIG. 4 is a plan view of an alternative embodiment of the present invention;

FIG. 5 is a perspective view showing the detail of a portion of the stencil of FIG. 4;

FIG. 6 is a perspective view of a first stencil interlocked with a second stencil according the alternative embodiment of FIG. 4;

FIG. 7 is a side view showing the detail of a portion of the interlocked stencils of FIG. 6;

FIG. 8 is a perspective view of a first stencil interlocked with a second stencil according to an embodiment of the present invention; and

FIG. 9 is a perspective view of a first stencil connected to a second stencil according to an embodiment of the present invention.

### DETAILED DESCRIPTION OF THE INVENTION

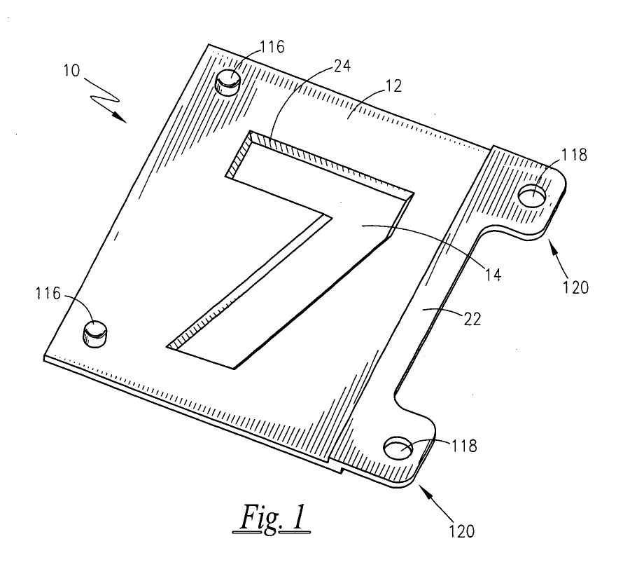

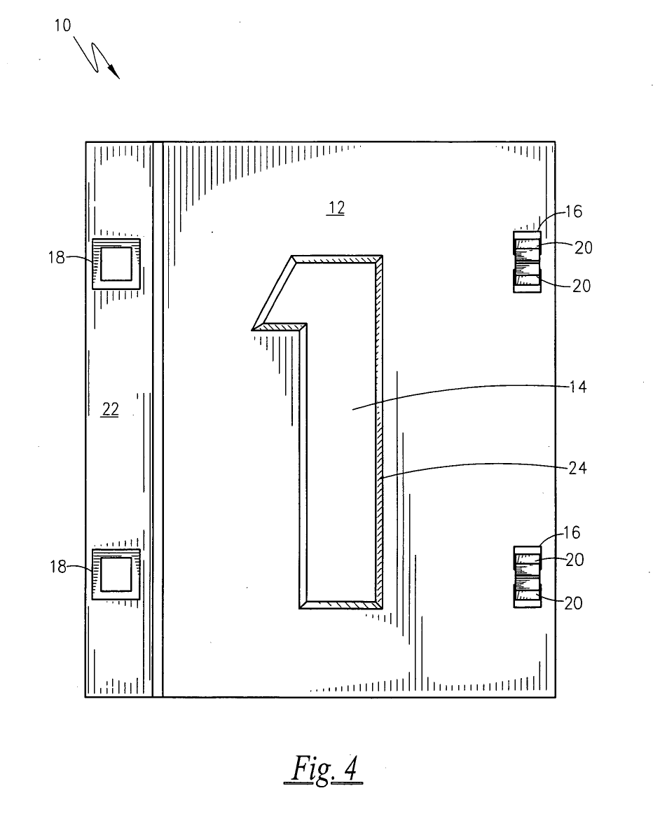

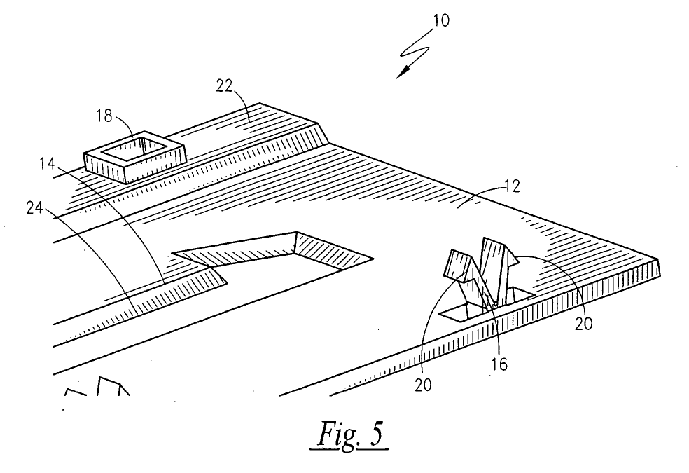

As shown in FIGS. 1-9, the present invention provides a modular stencil system including reusable interlocking stencils for use in spray painting or otherwise applying numbers, letters or other symbols onto a surface, such as by marking, crayoning, penciling, brush painting, roller painting, or sponge painting, for example. As presently embodied, each stencil 10, 10a, 10′, 10a′ comprises a stencil plate or body 12, 12a, 12′ 12a′ and a design area or stencil aperture 14, 14′, 14a′ in the shape of a particular symbol. Further, the apertures 14, 14′, 14a′ are not limited to a textual symbol, as described herein, and can be provided in any desired shape in accordance with the present invention. The stencils 10, 10a, 10′, 10a′ shown in FIGS. 1-3B and FIG. 9, by way of example, have apertures 14, 14′ shaped as the numbers “7” and “0” and the stencils 10, 10a, 10′, 10a′ shown in FIGS. 4-8, by way of example, have apertures 14, 14′, 14a′ shaped as the number “1”

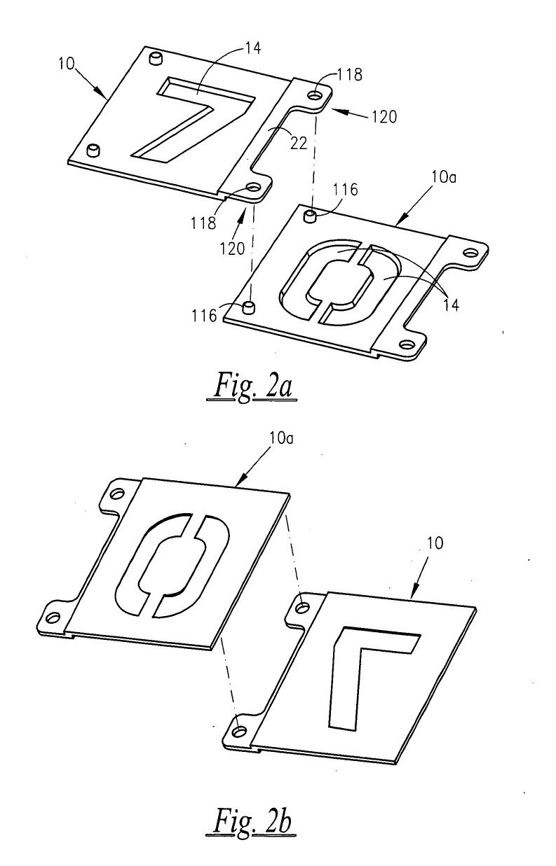

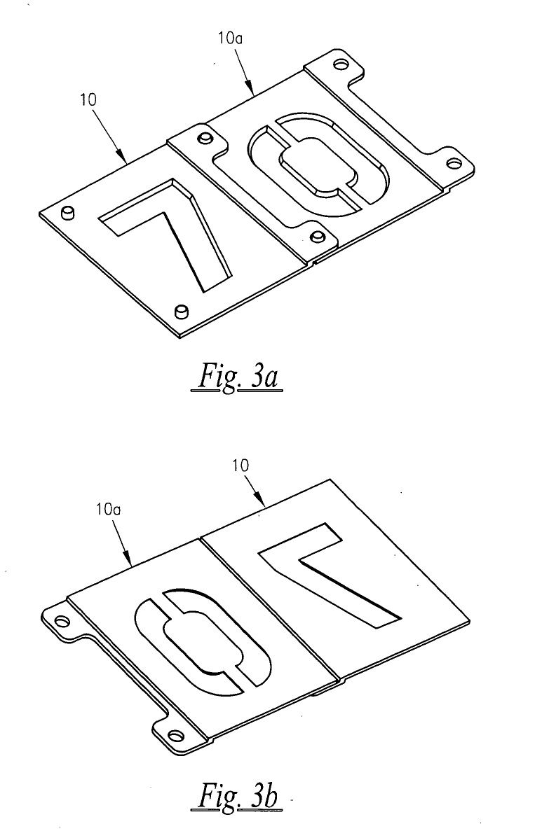

In the embodiment of FIGS. 1-3B, two upwardly raised cylindrical joining protrusions 116 and two corresponding cylindrical joining protrusion receiving apertures 118 are provided for the purpose of interconnecting a stencil 10 with an adjacent stencil 10a having corresponding raised joining protrusions 116 and joining protrusion receiving apertures 118. Each protrusion receiving aperture 118 is provided on an offset portion 22 that is raised upwardly from a top surface of the stencil body 12. As best shown in FIGS. 2A-3B, two adjacent stencils 10, 10a can be lockingly interconnected by inserting the raised joining protrusions 116 of the first stencil 10 into the respective protrusion receiving apertures 118 of the second stencil 10a. The respective protrusions 116 and apertures 118 are sized to provide a substantially tight fit to hold the adjacent stencils 10, 10a together (see FIGS. 3A and 3B) during the intended use, while allowing the stencils 10, 10a to be separated (see FIGS. 2A and 2B) as necessary.

The offset portion 22 is shown as having a generally C-shape and comprising lateral projections 120 on which the joining protrusion receiving apertures 118 are located. The offset portion 22 is not limited to a generally C-shape, and can be provided in any desired shape, for example, rectangular, semi-circular, or an asymmetrical shape, in accordance with the present invention.

The joints formed between respective protrusions 116 and apertures 118 that hold the stencils 10, 10a together are press fit joints. As used herein, the terms “press fit joint” refers to a connection formed by static friction forces due to the mutual pressure acting on the contact surfaces between a protrusion and a corresponding aperture into which the protrusion is inserted. The protrusions 116 and corresponding apertures 118 are adapted to permit the manual connection and disconnection of stencils 10, 10a. For example, the protrusions 116 and corresponding apertures 118 are adapted to permit the manual insertion of a protrusion 116 on a stencil 10, 10a into an aperture 118 on another stencil 10, 10a to a depth at which the stencils are substantially coplanar and connected by a press fit joint. Furthermore, stencils 10, 10a so connected by a press fit joint are adapted to be disconnected by manually, for example, by pulling apart so connected stencils 10, 10a. Alternatively, protrusions 116 and corresponding apertures 118 can be adapted to require the assistance of a tool, for example, a weight, a hammer, pliers, or a manual or powered vise, for connection and disconnection of the press fit joint. The cylindrical protrusions 116 and apertures 118 of the embodiment of FIGS. 1-3B can be replaced with protrusions and corresponding apertures of any other suitable shape, such as frustoconical or polygonal protrusions and apertures, for example.

As an alternative, as shown in FIG. 9, the relative locations of the raised joining protrusions 116′ and joining protrusion receiving apertures 118′ are reversed. so that the raised joining protrusions 116′ project downward from the offset portion 22′. Thus situated, the joining protrusions 116′ can engage the protrusion receiving apertures 118′ located on the stencil body 12′ by insertion from above.

Referring to FIGS. 4-7, to the extent that an alternative embodiment shown therein has features which substantially correspond to the above description of FIGS. 1-3B, the same reference characters will be used. Two locking tabs 16 and two tab-receiving apertures 18 are provided. Each locking tab 16 comprises two diverging hook-like projections or latching fingers 20 extending upwardly from the top surface of the stencil body 12. Each tab-receiving aperture is provided on the offset portion 22 that is raised upwardly from the top surface of the stencil body 12. Two adjacent stencils 10, 10a can be lockingly interconnected by inserting the locking tabs 16 of the first stencil 10 into the respective tab-receiving apertures 18a of the second stencil 10a. The latching fingers 20 engage or latch onto the stencil body 12a near the tab-receiving apertures 18a, thereby connecting the stencil bodies 10, 10a. The latching fingers 20 are resilient and bendable, which allows the latching fingers to be momentarily moved to a disengaging position. When the latching fingers 20 are in the disengaging position, two connected stencil bodies 10, 10a can be separated. In one embodiment of the invention, the movement of one or both of the two latching fingers 20 of each of the two locking tabs 16 to the disengaging position allows two stencil bodies 10, 10a to be disconnected. In another embodiment, the movement of both of the latching fingers 20 to disengaging positions is required for the stencil bodies 10, 10a to be disconnected.

During use, the hook-like latching fingers 20 of the locking tabs 16 prevent the locking tabs 16 from being inadvertently removed from the tab-receiving apertures 18a. In order to disconnect the stencils 10, 10a, the user squeezes or compresses the hook-like latching fingers 20 together, that is, to the disengaging position, allowing the tabs 16 to clear the tab-receiving apertures 18a.

The outside edge 24 of the stencil aperture 14 of the stencil 10 is tapered inward, or beveled, at exactly a 45 degree angle or at an approximately 45 degree angle from front to back. As used herein, the term “approximately” refers to an inclusive range beginning slightly below, and ending slightly above. For example, angles of 41, 43, 46 and 49 degrees are each approximately 45 degrees. This bevel enhances the sharpness of the edges of the stenciled symbol, especially when spray painted. Alternatively, the outside edge 24 can be tapered at any desired angle less than 90 degrees or can be perpendicular to the front surface of the stencil body 12. Beveled edges can be provided on the outside edges of the stencil apertures of all embodiments disclosed herein.

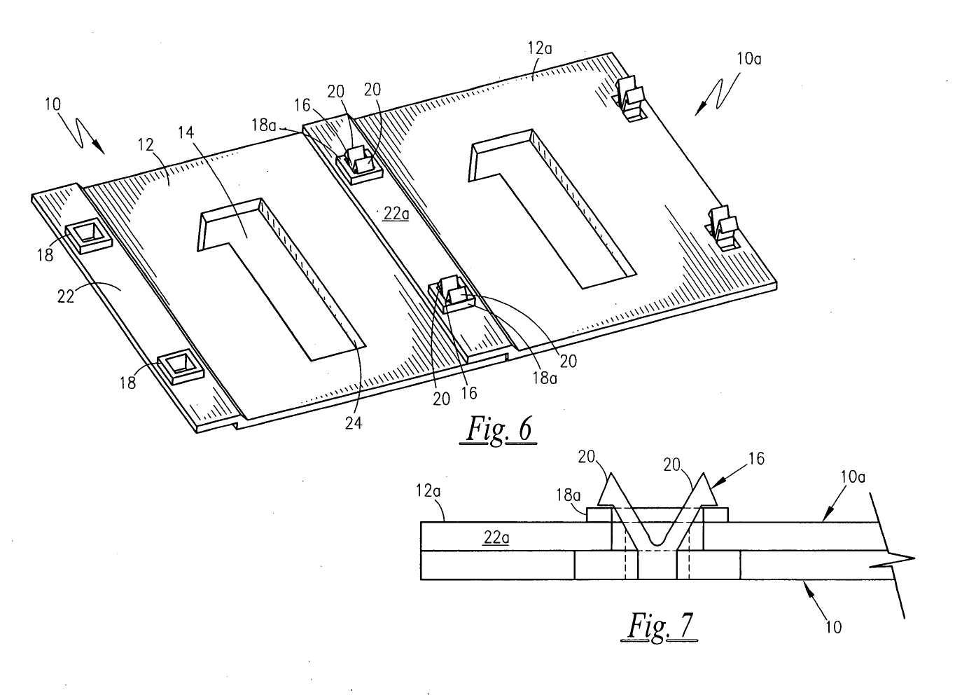

As shown in FIGS. 6 and 7, the offset portion 22a of the stencil body 12a overlaps the adjacent stencil body 12 and allows both of the stencils 10, 10a to lie flat, such that they have perfectly coplanar, or at least substantially coplanar, back surfaces when interconnected. As used herein, the terms “substantially coplanar” refer to planes in space that nearly, but not exactly, coincide, and which intersect to form small acute angles. An unlimited number of stencils 10, 10a can thus be interconnected in a serial fashion. Returning to FIGS. 3A and 3B, it can be seen that the interconnected stencils 10, 10a of the shown embodiment also have substantially coplanar back surfaces.

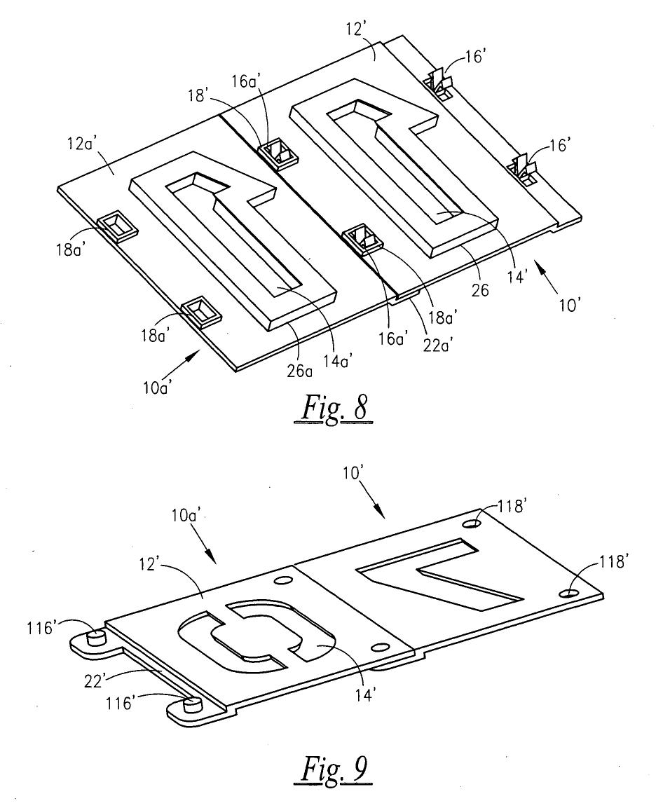

As an alternative, as shown in FIG. 8, the relative locations of the locking tabs 16′, 16a′ and tab-receiving apertures 18′, 18a′ are reversed. Accordingly, locking tabs 16a′ project downward from the offset portion 22a′. Thus situated, the locking tabs 16a′ can engage the tab-receiving apertures 18′ located on the stencil body 12a′ by insertion from above. Downward projecting lips 26, 26a surround the stencil apertures 14′, 14a′. The lips 26, 26a preferably project downward at least the same distance as the locking tabs 16′, 16a′. The lips 26, 26a prevent a liquid, for example, spray paint, that is applied to a surface through the stencils 10′, 10a′ from migrating under the stencil bodies 12′, 12a′ and contain the liquid within the stencil apertures 14′, 14a′.

The stencils 10, 10a, 10′, 10a′ of the disclosed embodiments are injection molded from a polymer material such as a plastic, for example, acrylonitrile-butadiene-styrene, phenolic, polyvinyl chloride, polyethylene, or polycarbonate. Alternatively, the stencils 10, 10a, 10′, 10a′ can be fabricated by blow molding, centrifugal molding, die cutting, stamping, pressing, cutting by hand or machine tool, or other known processes. Further, other suitable materials, including paper, cardboard, rubber, or metals, can be used to construct all or desired portions of the disclosed invention.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

1. A stencil system, comprising:
a first stencil body comprising a first stencil aperture and a raised joining protrusion that extends away from a top surface of the first stencil body; and
a second stencil body comprising a second stencil aperture and a joining protrusion receiving aperture, wherein said first stencil body and said second stencil body are connectable by a press fit joint between said raised joining protrusion and said joining protrusion receiving aperture.

2. The stencil system as set forth in claim 1, wherein a surface of said first stencil body and a portion of said second stencil body are substantially coplanar when the first stencil body is connected to the second stencil body.

3. The stencil system as set forth in claim 1, wherein said second stencil body includes an offset portion, and further wherein said joining protrusion receiving aperture is defined by said offset portion.

4. The stencil system as set forth in claim 1, wherein said first stencil body includes an offset portion, and further wherein said raised. joining protrusion extends from said offset portion.

5. The stencil system as set forth in claim 1, wherein at least one of said first stencil aperture and said second stencil aperture comprise a beveled edge.

6. The stencil system as set forth in claim 5, wherein a bevel angle of the beveled edge is approximately 45 degrees.

7. The stencil system as set forth in claim 6, wherein at least one of said first stencil body and said second stencil body comprises a polymer and is formed by a molding process.

8. A stencil system, comprising:
a first stencil body comprising a first stencil aperture and a raised joining protrusion that extends away from a top surface of the first stencil body, said raised joining protrusion comprising a first latching finger and a second latching finger; and
a second stencil body comprising a second stencil aperture and a joining protrusion receiving aperture, wherein said first stencil body and said second stencil body are connectable by a resilient latching joint between said raised joining protrusion and said joining protrusion receiving aperture.

9. The stencil system as set forth in claim 8, wherein said first stencil body and said second stencil body are connectable by engagement of at least one of said first latching finger and said second latching finger with said second stencil body, and further wherein said first latching finger and said second latching finger are receivable within said joining protrusion receiving aperture.

10. The stencil system as set forth in claim 9, wherein repositioning said first latching finger to a first disengagement position and said second latching finger to a second disengagement position allows said first stencil body to be disconnected from said second stencil body.

11. The stencil system as set forth in claim 9, wherein repositioning one of said first latching finger and said second latching finger to a disengagement position allows said first stencil body to be disconnected from said second stencil body.

12. The stencil system as set forth in claim 8, wherein a surface of said first stencil body and a portion of said second stencil body are substantially coplanar when the first stencil body is connected to the second stencil body.

13. The stencil system as set forth in claim 8, wherein said second stencil body includes an offset portion, and further wherein said joining protrusion receiving aperture is defined by said offset portion.

14. The stencil system as set forth in claim 8, wherein said first stencil body includes an offset portion, and further wherein said raised joining protrusion extends from said offset portion.

15. The stencil system as set forth in claim 8, wherein at least one of said first stencil aperture and said second stencil aperture comprises a beveled edge.

16. The stencil system as set forth in claim 15, wherein a bevel angle of the beveled edge is approximately 45 degrees.

17. The stencil system as set forth in claim 16, wherein at least one of said first stencil body and said second stencil body comprises a polymer and is formed by a molding process.

18. A stencil for connection to other stencils, the stencil comprising:
a stencil body defining a stencil aperture, said stencil aperture comprising a beveled edge having at least one bevel angle, wherein said at least one bevel angle is less than ninety degrees;
an offset portion of the stencil body for overlapping a stencil body of another stencil; and
a joining structure being provided on the offset portion.

19. The stencil as set forth in claim 18, wherein the joining structure comprises a joining protrusion receiving aperture for receiving a raised joining protrusion provided on a stencil body of another stencil.

20. The stencil as set forth in claim 19, wherein said joining protrusion receiving aperture is provided for forming a press fit joint with a raised joining protrusion provided on a stencil body of another stencil.

21. The stencil as set forth in claim 19, wherein said raised joining protrusion provided on the stencil body of another stencil comprises a first resilient latching finger for engaging said offset portion and a second resilient latching finger for engaging said offset portion.

22. The stencil as set forth in claim 18, wherein the joining structure comprises a raised joining protrusion for connecting to a joining protrusion receiving aperture on a stencil body of another stencil.

23. The stencil as set forth in claim 22, wherein said raised joining protrusion is provided for forming a press fit joint with a joining protrusion receiving aperture on a stencil body of another stencil.

24. The stencil as set forth in claim 22, wherein said raised joining protrusion comprises a first resilient latching finger for engaging a stencil body of another stencil and a second resilient latching finger for engaging a stencil body of another stencil.

25. A modular stencil system, comprising:
a first stencil body comprising a first cylindrical raised joining protrusion that extends away from a top surface of said first stencil body, a second cylindrical raised joining protrusion that extends away from the top surface of said first stencil body, a first offset portion comprising a first lateral projection and a second lateral projection, a first joining protrusion receiving aperture on said first lateral projection, a second joining protrusion receiving aperture on said second lateral projection, and a first stencil aperture, wherein said first stencil aperture is defined by a first beveled edge having a first bevel angle of approximately 45 degrees, and further wherein said first stencil body comprises a polymer and is formed by an injection molding process; and
a second stencil body comprising a third cylindrical raised joining protrusion that extends away from a top surface of said second stencil body, a fourth cylindrical raised joining protrusion that extends away from the top surface of said second stencil body, a second offset portion comprising a third lateral projection and a fourth lateral projection, a third joining protrusion receiving aperture on said third lateral projection, a fourth joining protrusion receiving aperture on said fourth lateral projection, and a second stencil aperture, wherein said second stencil aperture is defined by a second beveled edge having a second bevel angle of approximately 45 degrees, and further wherein said second stencil body comprises a polymer and is formed by an injection molding process, and further wherein said first stencil body and said second stencil body are connectable by a press fit joint between said first cylindrical raised joining protrusion and one of said third joining protrusion receiving aperture and said fourth joining protrusion receiving aperture, and further wherein said first stencil body and said second stencil body are connectable by a press fit joint between said second cylindrical raised joining protrusion and the other one of said third joining protrusion receiving aperture and said fourth joining protrusion receiving aperture, and further wherein a surface of said first stencil body and a portion of said second stencil body are substantially coplanar when said first stencil body is connected to said second stencil body.
